(19) United States
(12) Patent Application Publication
(10) Pub. No.: US 2004/0188888 A1
(43) Pub. Date: Sep. 30, 2004

(54) Film materials with pronounced imaging and method for making the same

(76) Inventors: Michael Putnam, Fuquay Varina, NC (US); Thomas Hill, Cary, NC (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 10/756,091

(22) Filed: Jan. 13, 2004

Related U.S. Application Data
(60) Provisional application No. 60/440,570, filed on Jan. 15, 2003.

(51) Int. Cl. H05B 6/64; B32B 31/00; B32B 31/30; B29C 47/06

(52) U.S. Cl. 264/474; 264/509; 264/490; 264/171.13

(57) ABSTRACT

In accordance with the present invention, a thermoplastic film is advanced onto a foraminous surface and impinged with hydraulic energy so as to impart an image or pattern into the film. In an effort to retain the image or pattern within the film, the film is exposed to a frequency range during the drying process, such as that frequency range which is provided by microwaves. It has been found that utilizing a frequency range of electro-magnetic radiation, like that of microwaves during the drying process of the film does not flatten or distort the image or pattern within the film, whereas a drying process utilizing hot air tends to soften the film, which has a deleterious on the image within the film.

### TECHNICAL FIELD

The present invention generally refers to a method of making thermoplastic films that have been imaged on a foraminous surface, and more specifically to a method of making an imaged film that embodies a more pronounced and dimensionally stable image.

### BACKGROUND OF THE INVENTION

Films are used in a wide variety of applications where the engineered qualities of the apertured and/or unapertured film can be advantageously employed as a component substrate. The use of selected thermoplastic polymers in the construction of film products, selected treatment of the polymeric films (either while in melt form or in an integrated structure), and selected use of various mechanisms by which the film is integrated into a useful construct, are typical variables by which to adjust and alter the performance of the resultant polymeric film product.

The formation of finite thickness films from thermoplastic polymers is a well known practice. Thermoplastic polymer films can be formed by either dispersion of a quantity of molten polymer into a mold having the dimensions of the desired end product, known as a thermo-formed or injection-molded film, or by continuously forcing the molten polymer through a die, known as an extruded film. Extruded thermoplastic polymer films can either be formed such that the film is cooled then wound as a completed product, or dispensed directly onto a substrate material to form a composite material having performance of both the substrate and the film layers. Examples of suitable substrate materials include other films, polymeric or metallic sheet stock and woven or nonwoven fabrics.

The application of the extruded film directly onto a substrate material imparts the substrate material with enhanced physical properties. It is known in the art that the application of a thermoplastic polymer film having suitable flexibility and porosity onto a nonwoven fabric results in a composite material having significant barrier properties and is suitable for disposable protective garment manufacture.

To further improve the performance of the thermoplastic polymer film when used in composite material manufacture, various additives are admixed with the thermoplastic polymer prior to or during extrusion. Typical additives employed are those selected from various colorants or opacifiers, such as titanium dioxide. Water insoluble salts such as calcium carbonate may be added to the polymer mix resulting in a film that can be rendered micro-porous by the application of draft tension, as taught by U.S. Pat. No. 5,910,225 to McAmish, hereby incorporated by reference. If there is a desire to form a composite wherein the thermoplastic polymer film will be exposed to a transitory temperature above the melting temperature of the polymer, antioxidants can be incorporated into the mix to aid in reducing thermal degradation. In the event where the family of thermoplastic polymers to be used in the extruded film exhibits a dissimilar characteristic such as surface energy from the thermoplastic polymer of the substrate material, compatibilizers are incorporated into the polymer mix.

Film substrates are desirable for a variety of end-use applications due to the barrier performance such substrates can provide. Films have proven to be particularly suitable for a variety of medical, hygiene, and industrial applications and when utilized in a laminate construct, permits cost-effective, disposable use. Use of such materials for sanitary napkins, medical wipes, and the like has become increasingly widespread, since the use of a nonwoven fabric constructs can provide a desired softness that may be required for specific medical and hygiene applications.

In certain end-use applications it is advantageous to impart an aesthetic quality into a film substrate by way of embossing or three-dimensionally imaging the film. Typically, imaged or other embossed films are exposed to hydraulic energy while on a foraminous surface, such as a three-dimensional image transfer device, so as to impart an image into the film substrate. Such three-dimensional image transfer devices are disclosed in U.S. Pat. No. 5,098,764, which is hereby incorporated by reference, with the use of such image transfer devices being desirable for providing a film with enhanced physical properties as well as an aesthetically pleasing appearance. Subsequent to the imaging process, the imaged film is subjected to elevated air temperatures during the drying process, which can soften the resultant film having a deleterious affect on the overall three-dimensionality of the imaged or embossed film. An unmet need remains for an imaged or embossed thermoplastic film comprising a pronounced, as well as a defined image.

### SUMMARY OF THE INVENTION

The present invention is directed to a method of making thermoplastic apertured and/or unapertured films that have been imaged on a foraminous surface, such as a three-dimensional image transfer device, and more specifically to a method of making an imaged film that embodies a more pronounced and dimensionally defined image.

In accordance with the present invention, a thermoplastic film is advanced onto a foraminous surface and impinged with hydraulic energy so as to impart an image or pattern into the film. In an effort to retain the image or pattern within the film, the film is exposed to a frequency range during the drying process, such as that frequency range which is provided by microwaves. It has been found that utilizing a frequency range of electromagnetic radiation, like that of microwaves during the drying process of the film does not flatten or distort the image or pattern within the film, whereas a drying process utilizing hot air tends to soften the film, which has a deleterious on the image within the film.

The film substrate may be that of various olefinic thermoplastic polymers including, but are not limited to, isotactic polypropylene, linear low-density polyethylene, low-density polyethylene, high-density polyethylene, amorphous polypropylene, polybutylene, ethylene/vinyl acetate copolymer, ethylene/ethyl acrylate copolymer, ethylene/methyl acrylate copolymer, polystyrene, and the combination thereof.

In one embodiment of the present invention, the film substrate is unwound from an unwind station and advanced onto a foraminous surface where the film is subjected to hydraulic energy thereby imparting an image or pattern into the film. The foraminous surface may be that of a belt, screen, or three-dimensional image transfer device. The film may be comprised of one or more patterns or images that protrude from the surface of the film. Further, it is within the purview of the invention that the film may comprise apertures of various shapes and sizes.

The preferred method contemplates the provision of a three-dimensional image transfer device having a movable imaging surface. In a typical configuration, the image transfer device may comprise a drum-like apparatus, which is rotatable with respect to one or more of the manifolds.

The film substrate is advanced onto the imaging surface of the image transfer device. Impingement of hydraulic energy on the film substrate is affected to form a three-dimensionally imaged film. Subsequent to being imaged on the three-dimensional image transfer device, the three-dimensionally imaged film may be subjected to one or more variety of post treatments, including but not limited to the application of a surfactant or electrostatic compositions, and like processes. The three-dimensionally imaged film is dried using a frequency range of electromagnetic radiation with the ability to preserve the pattern or image imparted within the film, such as the frequency range provided by microwaves. Further, the drying process of the film may optionally include the use of ultrasonics or other mechanical drying means so as to aid in the disruption of macrodroplets and expulsion off of the film surface.

In a second embodiment, the imaged film is part of a laminate construct, wherein the film may be directly extruded onto an additional film or fabric layer or juxtaposed with an additional layer and bonded so as to form a laminate construct.

Other features and advantages of the present invention will become readily apparent from the following detailed description, the accompanying drawings, and the appended claims.

### BRIEF DESCRIPTION OF THE DRAWINGS

FIG. 1 is a schematic representation of the processing apparatus for producing a film in accordance with the principles of the present invention; and

FIG. 2 is a schematic representation of the processing apparatus for imparting an image into the film of the present invention.

### DETAILED DESCRIPTION

While the present invention is susceptible of embodiment in various forms, there is shown in the drawings and will hereinafter be described a presently preferred embodiment of the invention, with the understanding that the present disclosure is to be considered as an exemplification of the invention, and is not intended to limit the invention to the specific embodiment illustrated.

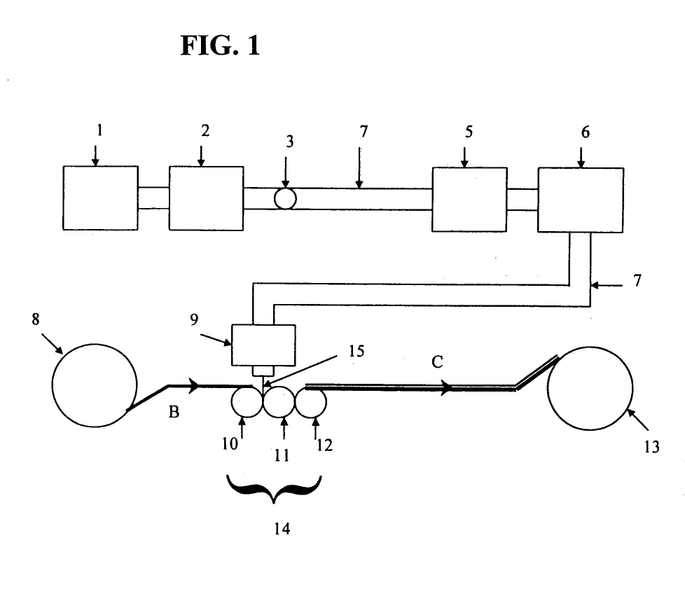

FIG. 1 depicts a representative direct extrusion film process. Blending and dosing system 1, comprising at least two hopper loaders for polymer chip and a mixing hopper. Variable speed augers within both hopper loaders transfer predetermined amounts of polymer chip and additive pellet to the mixing hopper. The mixing hopper contains a mixing propeller to further the homogeneity of the mixture. Basic volumetric systems such as that described are a minimum requirement for the blending zone system.

The polymer chip and additive pellet blend feeds into a multi-zone extruder 2 as supplied by the Wellex Corporation. In this particular system, a five zone extruder was employed with a 2 inch water-jacketed bore and a length to diameter ratio of 24 to 1. Upon mixing and extrusion from multi-zone extruder 2, the polymer compound is conveyed via heated polymer piping 7 through screen changer 3, wherein breaker plates having different screen meshes are employed to retain solid or semi-molten polymer chips and other macroscopic debris. The mixed polymer is then fed into melt pump 5.

Melt pump 5 operates in dynamic feed back with the multi-zone extruder 2 to maintain the desired pressure levels. A gear-type melt pump was employed to respond to pressure levels by altering the speed of the extruder to compensate for deviations from the pressure set point window.

The metered and mixed polymer compound then enters combining block 6. The combining block allows for multiple film layers to be extruded, the film layers being of either the same composition or fed from different systems as described above. The combining block 6 is directed into die body 9 by additional heated polymer piping 7.

The particular die body 9 employed in this system is a 37 inch wide EDI Automatic Die with die bolt control as supplied by EDI. The die body 9 is positioned in an overhead orientation such that molten film extrusion 15 is deposited at the nip point in cast station 14, between nip roll 10 and cast roll 11.

The film substrate may optionally be directly extruded onto or thermally bonded to an additional film or fabric layer, forming a laminate structure, and advanced onto a foraminous surface to be imparted with an image or pattern or the extruded film or film laminate may be wound into a roll and transferred to an unwind station, wherein the film is unwound and advanced onto a foraminous surface.

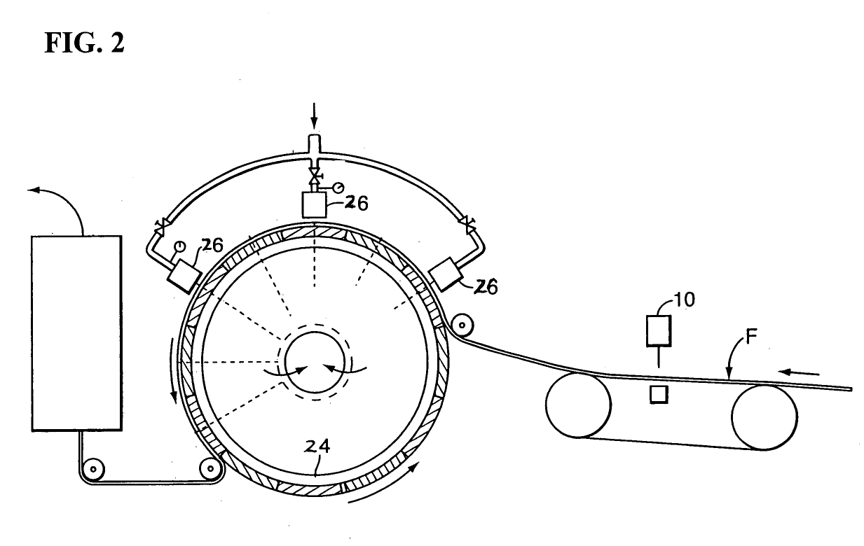

FIG. 2 depicts the means for imparting the three-dimensional quality into the film during the manufacturing process. FIG. 2 includes an imaging and patterning drum 24 comprising a three-dimensional image transfer device for effecting imaging and patterning of the film substrate. The apparatus includes a plurality of manifolds 26, which act in cooperation with the three-dimensional image transfer device of drum 24 to effect patterning of the film. In the present example, the manifolds 26 use high pressure low flow and/or low pressure high flow water jets to transfer an image into the film.

Subsequent to imparting the image or pattern into the film, the film undergoes a dewatering or drying process utilizing a frequency range of electro-magnetic radiation, such as that of microwaves. The air temperatures of circulating air are kept lower for the purpose of removing water vapor generated by the frequency range. The air does not have to carry heat for water evaporation. This will enable drying without the image flattening. The volume of air required will reduce filtration needs in the manufacturing process. Frequency ranges, such as those provided by microwaves, are more effective at eliminating microscopic droplets which are prone to remain when air impingement drying is used. Further, the drying process of the film may optionally include the use of ultrasonics or other mechanical drying means so as to aid in the disruption of macrodroplets and expulsion off of the film surface.

The apertured and/or nonapertured film substrate of the present invention may be that of various olefinic thermoplastic polymers including, but are not limited to, isotactic polypropylene, linear low-density polyethylene, low-density polyethylene, high-density polyethylene, amorphous polypropylene, polybutylene, ethylene/vinyl acetate copolymer, ethylene/ethyl acrylate copolymer, ethylene/methyl acrylate copolymer, polystyrene, and the combination thereof.

Further, the film of the present invention may optionally be that of a reticulated film, microporous film, or monolithic film. A suitable process for forming a reticulated film is by utilization of the Reticulon Technology, as described in U.S. Pat. No. 4,381,326 to Kelly, hereby incorporated by reference. A suitable microporous film layer can include materials such as those reported in U.S. Pat. No. 5,910,225 herein incorporated by reference, in which pore-nucleating agents are used to form the micropores. Monolithic films as reported in U.S. Pat. No. 6,191,221, herein incorporated by reference, can also be utilized as a suitable film laminate means.

In the process of forming a laminate structure, the film of the present invention may be utilized with a variety of nonwoven substrates, such as a spunmelt layer.

The fibers or filaments of a spunmelt layer can be selected from a group of polyesters, polyamides, or polyolefins, such as polypropylene, polyethylene, and the combinations thereof. The fibers or filaments may also be one of a multi-component configuration of the above mentioned polymers. The fibers may also be staple-length fibers wherein the molten polymer is extruded and drawn, resulting in a tow, which is cut into finite staple-lengths.

A spunbond process involves supplying a molten polymer, which is then extruded under pressure through a large number of orifices in a plate known as a spinneret or die. The resulting continuous filaments are quenched and drawn by any of a number of methods, such as slot draw systems, attenuator guns, or Godet rolls. The continuous filaments are collected as a loose web upon a moving foraminous surface, such as a wire mesh conveyor belt. When more than one spinneret is used in line for the purpose of forming a multi-layered fabric, the subsequent webs is collected upon the uppermost surface of the previously formed web. The web is then at least temporarily consolidated, usually by means involving heat and pressure, such as by thermal point bonding. Using this bonding means, the web or layers of webs are passed between two hot metal rolls, one of which has an embossed pattern to impart and achieve the desired degree of point bonding, usually on the order of 10 to 40 percent of the overall surface area being so bonded.

A related means to the spunbond process for forming a layer of a nonwoven fabric is the melt blown process. Again, a molten polymer is extruded under pressure through orifices in a spinneret or die. High velocity air impinges upon and entrains the filaments as they exit the die. The energy of this step is such that the formed filaments are greatly reduced in diameter and are fractured so that microfibers of finite length are produced. The extruded multiple and continuous filaments can be optionally imparted with a selected level of crimp, then cut into fibers of finite staple length. These thermoplastic resin staple fibers can then be subsequently used to form textile yarns or carded and integrated into nonwoven fabrics by appropriate means, as exemplified by thermobonding, adhesive bonding, and hydroentanglement technologies. The process to form either a single layer or a multiple-layer fabric is continuous, that is, the process steps are uninterrupted from extrusion of the filaments to form the first layer until the bonded web is wound into a roll.

Further, alternate spunmelt layers include fine denier or nano-denier layers. Suitable nano-denier continuous filament barrier layers can be formed by either direct spinning of nano-denier filaments or by formation of a multi-component filament that is divided into nano-denier filaments prior to deposition on a substrate layer. U.S. Pat. No. 5,678,379 and No. 6,114,017, both incorporated herein by reference, exemplify direct spinning processes practicable in support of the present invention. Multi-component filament spinning with integrated division into nano-denier filaments can be practiced in accordance with the teachings of U.S. Pat. No. 5,225,018 and No. 5,783,503, both incorporated herein by reference.

In the process of forming a laminate structure, the film of the present invention may be utilized with a staple fiber substrate, including substrates formed of natural and synthetic fibers, such as polyesters, polyolefins, polyamides, and the blends thereof. Such substrates may comprise fibers of various cross-sectional shapes, as well as bi-component fibers. In one embodiment, it has been contemplated that a polyester/film laminate include a sufficient amount of rayon or pulp in the polyester nonwoven to lower the water reactivity to a point that deters bacterial growth. Further, incorporating rayon into the polyester helps protect the finished roll good should the finished roll be stored in an unconditioned warehouse, wherein changes in temperature or relative humidity may cause condensation that could raise the water reactivity during storage.

It is also within the purview of the present invention that the imaged film comprise a melt additive or topically applied additive that is specific to needs of the end-use application where the film is applied. Suitable additives may include, but are not limited to, thermochromics, UV stabilizers, wetting agents, softening agents, pigments, or a combination thereof. The imaged film or film laminate can be used in a variety of hygiene, medical, and industrial applications.

From the foregoing, it will be observed that numerous modifications and variations can be affected without departing from the true spirit and scope of the novel concept of the present invention. It is to be understood that no limitation with respect to the specific embodiments illustrated herein is intended or should be inferred. The disclosure is intended to cover, by the appended claims, all such modifications as fall within the scope of the claims.

What is claimed is:

1. A method of making an imaged thermoplastic film, comprising the steps of:
providing a thermoplastic film;
providing a foraminous surface;
unwinding said thermoplastic film;
advancing said film onto said foraminous surface;
impinging said film with hydraulic pressure so as to impart an image into said film; and
drying said imaged thermoplastic film, wherein said drying process comprises the use of a frequency range of electromagnetic radiation that preserves said image imparted into said film.

2. A method of making an imaged thermoplastic film as in claim 1, wherein said foraminous surface is a three-dimensional image transfer device.

3. A method of making an imaged thermoplastic film as in claim 1, wherein said frequency range is provided by microwaves.

4. A method of making an imaged thermoplastic film, comprising the steps of:
providing a thermoplastic polymeric melt;
providing a support layer;
providing a foraminous surface;
extruding said polymeric melt directly onto said support layer so as to form a laminate;
advancing said film laminate onto said foraminous surface;
impinging said film laminate with hydraulic pressure to impart an image into said film laminate; and
drying said imaged thermoplastic film, wherein said drying process comprises the use of a frequency range of electromagnetic radiation that preserves said image imparted into said film.
